(19) United States
(12) Patent Application Publication
(10) Pub. No.: US 2005/0127056 A1
(43) Pub. Date: Jun. 16, 2005

(54) System for drying equipment

(76) Inventors: Ivan E. Petkov, Carbondale, CO (US); Sven Coomer, Carbondale, CO (US)

Correspondence Address: GLENN L. WEBB, P.O BOX 951, CONIFER, CO, 80433, US

(21) Appl. No.: 10/709,584

(22) Filed: May 15, 2004

Related U.S. Application Data
(63) Continuation-in-part of application No. 10/267,024, filed on Oct. 7, 2002, now abandoned.

(51) Int. Cl. H05B 1/00

(52) U.S. Cl. 219/211

(57) ABSTRACT

The present invention provides a bag, box or other compartmentalized storage and/or transportable system for heating and/or drying articles in the system. The bag includes at least one heating element that transmits sufficient heat to dry and heat articles, such as boots, shoes, clothing, equipment and the like, from the outside inward to completely dry the articles. The heating elements are connected to a power source, such as electrical outlet, vehicle DC power adaptor or battery source.

### BACKGROUND OF INVENTION

Often, during many sports activities, the associated gear will become at the very least damp, if not wet. Such activities include skiing, snowboarding, hiking, swimming, and many other activities. Even such activities as running, tennis, basketball, racketball, etc. can lead to sweaty shoes and clothing. It has often been a problem with transporting and storing of this gear while it is still damp or wet.

For example, it is very common for ski boots to become damp with body moisture as well as snow and ice during use. The boots are then transported in a bag or vehicle to the skier's lodging (unless the skier happens to be in a ski in/ski out location) and then either brought inside or left in the vehicle. The lining of the boots, if the skier is conscientious, are then taken out of the shells to dry. Failure to do so can cause discomfort for the skier the next day when the skier puts on boots with wet linings.

There have been a number of attempts to solve this particular problem. For instance, a boot warmer is disclosed in U.S. Pat. No. 6,148,545. This particular warmer has a deformable, heat retaining, material that is heated in a microwave and then placed in the damp boot. Another technique is to use a blow-dryer to blow hot air into the boot. Another technique is insert heated physical therapy packs into the boot to dry it. There is also a commercially available electric boot dryer by Therm-IC that is placed into the boot. An AC element circulates heat in the boot to dry them. Other types of ski boot and shoe drying systems use room temperature or warmed air blown through tubes that are inserted into the ski boots to dry out the liners.

There are a number of problems associated with these prior devices. One problem is the lack of access or availability of commercial units, such as used in commercial ski storage rooms and rental facilities. Also, many people do not desire to purchase home units, plus the necessity of remembering to use them. Additionally, there is often a considerable time factor from when the skier or snowboarder leaves the slope to when they return to their destination. The condensed moisture and/or snow and ice melts and seeps in between the liner and boot structure before arrival. Moisture will often leak or condense within the boot structure between the shell and the lining. Even if the lining is later dried, it is difficult to dry the boot structure itself. That is a critical problem even with the use of the commercially available units. The moisture remaining within the lining or between the parts of the external boot structure will then become cold and uncomfortable once the heat is removed, and the boot structure becomes cold and stiff. Even if the lining is dried satisfactorily, the shell of the boot will remain cold and stiff. This creates inconvenience and discomfort for the user.

Other examples of the problems associated with damp or wet equipment is found in many other activities. For example, many recreational athletes transport their sports clothes, shoes, and other gear in an equipment bag. These clothes, shoes and gear are put back in the bag after use, typically damp or wet. These articles do not usually dry out until removed from the bag which may be hours if not longer, particularly shoes and equipment. This causes not only the growth of odor, bacteria, etc. but may also degrade the performance of these articles.

Another problem that frequently arises is in the use of wet garments and other items, such as wet suits used in diving, kayaking and other water sports. These suits are uncomfortable to put on when damp and wet. These suits may feel clammy and otherwise are uncomfortable when first put on wet. This often becomes an issue during frequent use of these suits.

As outdoor activities and participation increases, these and other associated problems arise from the transport and storage of damp or wet articles. There is presently a need for solutions to these problems.

### SUMMARY OF INVENTION

The present invention solves these and other problems by providing a heated compartment in a bag, box or other structure. The heated compartment includes a heating element that heats articles in the compartment from the outside inward to dry moisture from the articles in the compartment as well as to sterilize any body moisture in the articles. The heating of the articles from the outside towards the inside of the articles evacuates the moisture from all of the components of boots or other articles and from any inner linings.

In a preferred embodiment, the present invention provides at least one compartment in a boot or sports bag. A heating element extends along the side walls and bottom surface to evenly distribute heat to boots or other articles in the compartment. The heating element is connectable to a power source that may include an AC power cord for connection to an appropriate electrical outlet, with a DC adaptor for connection to a vehicle power source or a battery source.

The heating elements, in one preferred embodiment, includes a thermostat to maintain the compartment temperature within a specified range, such as 120 degrees Fahrenheit. Other embodiments may utilize a timer to cycle the heating element on and off for specified times.

The present invention, in at least one preferred embodiment, provides insulation on the exterior side walls of the heating element to minimize the loss of heat to the ambient outside temperature. Reflective materials may also be used for this purpose. The inner side walls and bottom surface may also include insulation to assure even heating of the inner compartment.

In another preferred embodiment, the bottom surface of the compartment may allow direct contact with the heating element. This allows greater heating to the soles of the boots or footwear allowing heat to radiate upwards, naturally and progressively from the soles.

The heating element can be laminated with conductive film, such as aluminum film to disperse heat uniformly.

Other embodiments of the present invention include bags with separate compartments. These separate compartments may use a common heating element or separate controllable heating elements. The present invention may also be usable in storage boxes that are used in residences, lodging, lockers, commercial storage facilities and other locations.

A preferred embodiment of the present invention uses a ventilation system to evaporate moisture during the drying process. This promotes quicker drying and minimizes the collection of moisture in the bag.

Another preferred embodiment provides a system for drying wet suits and other garments and large items. The wet suit is folded over a center sleeve containing a heating element. The bag is then hung in a vertical orientation and the heating element is powered. The moisture is either evaporated into the surrounding air or collected by sponges or other retention devices.

The present invention also includes embodiments for use of the heated compartments for all types of sports activities, work activities, food service, medical services and any other use where heating and/or drying of articles is useful.

These and other features will be evident from the detailed description of preferred embodiments and from the drawings.

### BRIEF DESCRIPTION OF DRAWINGS

FIG. 1 is a perspective view of a heated travel bag of a preferred embodiment of the present invention.

FIG. 2 is cut-away view of the embodiment of FIG. 1.

FIG. 3 is schematic illustration of a preferred embodiment of controls and power sources for the heating element.

FIG. 4 is a perspective view of a heated shoe bag of a second embodiment of the present invention.

FIG. 5 is a cut-away view of the embodiment of FIG. 4.

FIG. 6 is another cut-away view of the embodiment of FIG. 4.

FIG. 7 is a cut-away view of a multiple pair heated boot bag of a preferred embodiment of the present invention.

FIG. 8 is rear cutaway view of the embodiment of FIG. 7.

FIG. 9 is a perspective view of another embodiment of the present invention.

FIG. 10 is a cut-away view of the embodiment of FIG. 9.

FIG. 11 is another view of the embodiment of FIG. 9.

FIG. 12 is a perspective view of another embodiment of the present invention.

FIG. 13 is a perspective view of another embodiment of the present invention.

FIG. 14 is a perspective view of another embodiment of the present invention.

FIG. 15 is a perspective view of another embodiment of the present invention.

FIG. 16 is a perspective view of another embodiment of the present invention.

FIG. 17 is a perspective view of another embodiment of the present invention.

FIG. 18 is a perspective view of another embodiment of the present invention.

FIG. 19 is an exploded view of the embodiment of FIG. 18.

FIG. 20 is a partial view of the embodiment of FIG. 18.

FIG. 21 is a end view of the embodiment of FIG. 18.

FIG. 22 is an open end view of the embodiment of FIG. 18.

FIG. 23 is an initial step in using the embodiment of FIG. 18.

FIG. 24 is an intermediate step in using the embodiment of FIG. 18.

FIG. 25 is a final step in using the embodiment of FIG. 18.

### DETAILED DESCRIPTION

The present invention provides a system for heating and drying articles. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the components of the heating and drying systems are discussed, other equivalents to these embodiments that perform substantially similar functions are within the scope of the claimed inventions.

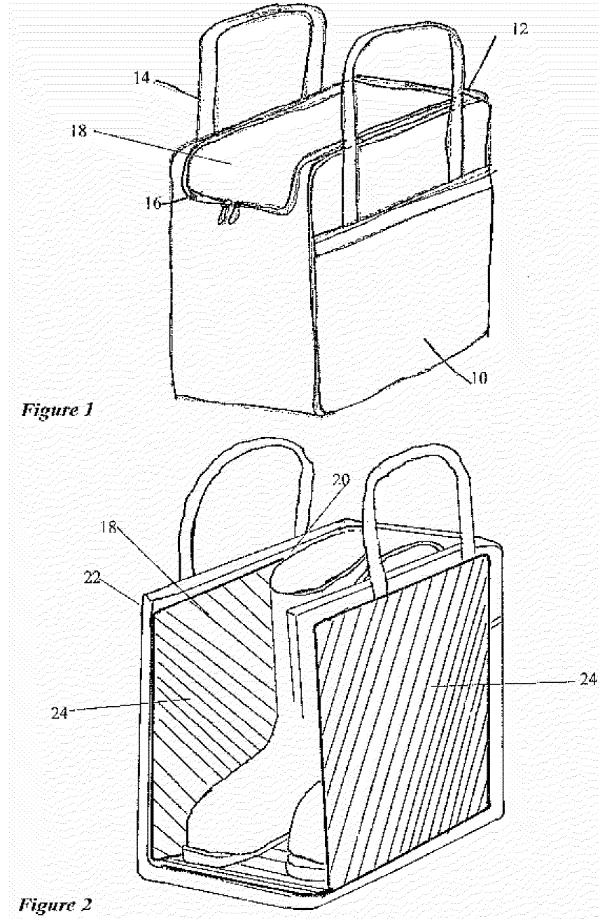

A preferred embodiment of the present invention is illustrated in FIGS. 1-2. In this preferred embodiment, described herein for explanatory purposes and not to limit the scope of the present invention, the heating and drying system 10 includes a transportable container 12. In this embodiment, the transportable container is a boot bag, as shown in FIGS. 1-2. The boot bag of this preferred embodiment is a soft bag with handles 14, a zippered (or other well known fastening mechanisms) opening 16 and an internal compartment 18 for carrying ski boots, snow boarding boots, or other equipment articles. A ski boot bag is discussed herein only for explanatory purposes and is not meant to limit the claimed inventions to this particular embodiment. The internal compartment 18 includes inner walls 20 and outer walls 22.

Heating element 24 is contained in the bag 12 between the inner walls 20 and outer walls 22. The heating element 24, in this preferred embodiment, extends not only along the side walls but the bottom floor as well in order to assure consistent even dispersion of heat within the compartment. In other preferred embodiments, the heating element may only be in the side inner walls or the inner walls 20 may be eliminated and the heating elements radiate directly into the compartment 18. In this preferred embodiment, the inner walls 20 and outer walls 22 include an insulating material. Examples of this insulating material include EVA (Ethyl Vinyl Acetate) or PE (Polyethelene) foam with the inner facing layer laminated with heat reflective material. Other types of insulating material may be used as well. In the preferred embodiment, the outer walls 22 or the outer wall of the heating element 24 are laminated with heat reflective material. This helps to minimize loss of heat from outside ambient temperature, to disperse heating uniformly and to minimize the build up of hot spots due to the manner the bag or boots are stored.

In the preferred embodiment, the heating element includes a thermostat to maintain the temperature inside the compartment or on the heating element itself. This prevents overheating or under heating of the contents of the bag. In one preferred embodiment, the temperature inside the compartment is maintained near 120 degrees Fahrenheit. Alternatively, a timer may be used as well to turn the heating element on at preset times or off after a set time. The heating element is cycled on and off, i.e., two hours on and one hour off. The timer and thermostat, in one preferred embodiment, are adjustable by the user.

The heating element 24 includes a power source 30. In the preferred embodiment, the power source 30 includes a twelve volt battery supply 32 that is connected to a twelve volt DC adaptor that may be plugged into the cigarette or auxiliary power supply in a vehicle. Also, an AC adaptor that may also be used and plugged into a building wall outlet is included as well. In another embodiment, the power source 30 includes only the AC power source. The bag is sufficiently well insulated to maintain the internal temperature of the bag compartments for two hours or more without significant heat loss.

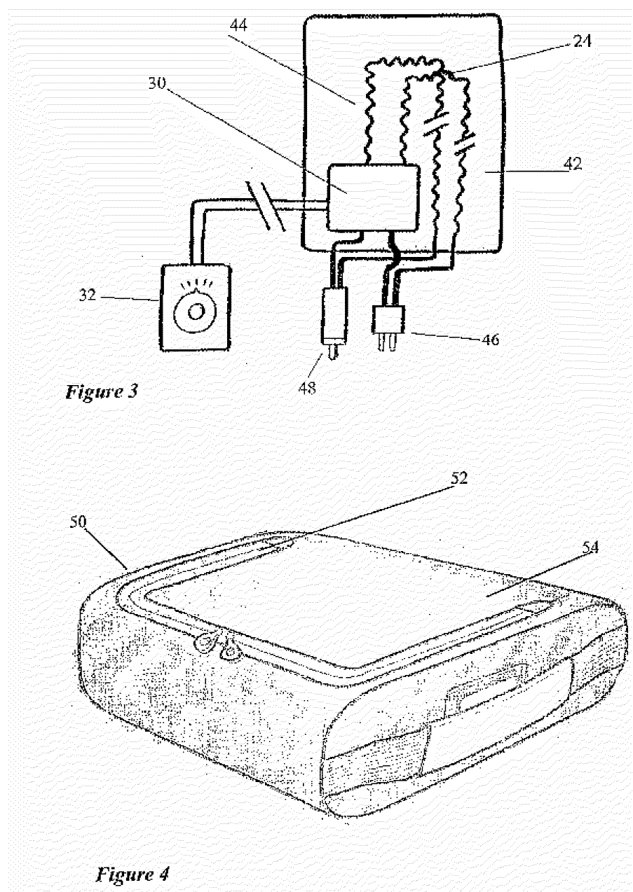

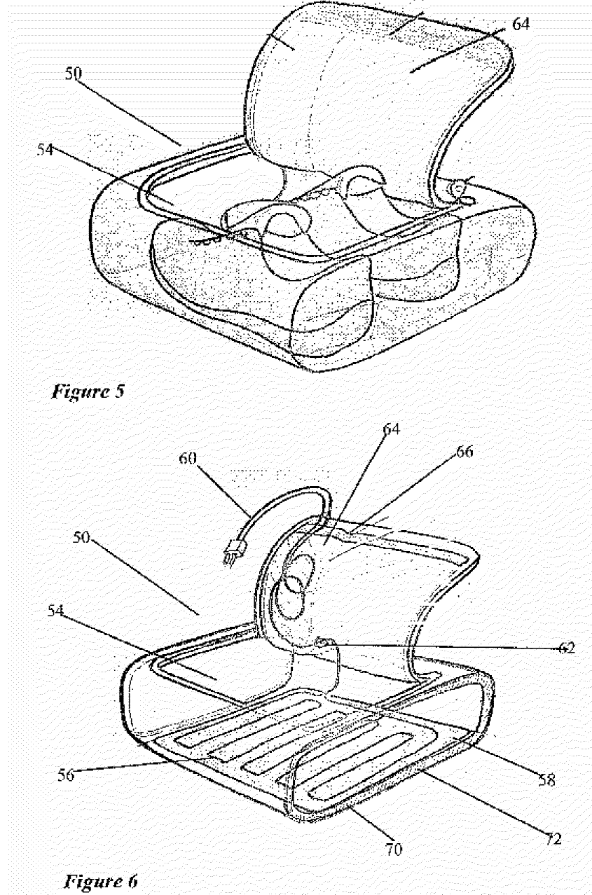

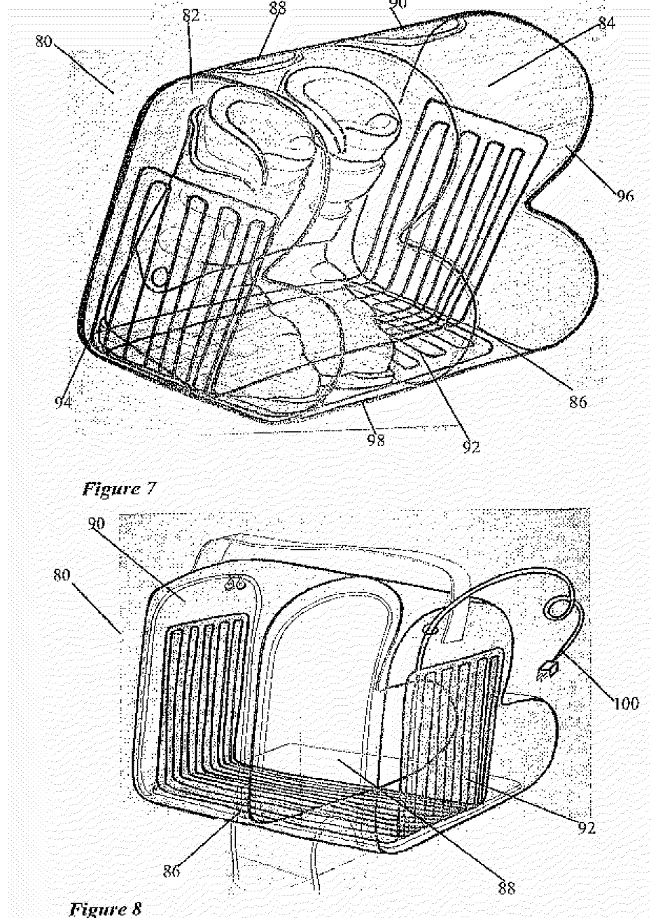

Another preferred embodiment of the power source 30 is illustrated in FIG. 3. The heating element 24 includes two combined heating elements 42, 44. Heating element 42 is connected to a first electrical power source 46 while heating element 44 is connected to a second electrical power source 48. First electrical power source may be plugged into a common residential United States AC volt use while second electrical power source 48 is intended for use with common European AC volt source. This allows the heated bag to be easily used in either continent without the need for additional power converters. Also, a DC power converter may also be included to allow the heated bag to be powered from a vehicle or other remote source. A thermostat 49 is also included that will maintain the appropriate heat or time to heat the compartment. This preferred embodiment is particularly useful in that it can be used with several different AC electrical power source, such as an indoor outlet or with a DC power source, such as a vehicle auxiliary power output (cigarette lighter plug). This provides greater flexibility and usability of the heated bag.

The heating element 24, in the preferred embodiment, is shown as a single flat element. However, it is to be expressly understood that multiple elements may be used. Also, the shape of the heating element may be varied as well depending on the shape of the bag, the compartment and the article to be heated. A flexible heating element may also be used that can be inserted into spaces in the articles to be heated, such as in a boot cuff, helmet interior space or other areas.

In use, the user places the cold and/or wet boots in the compartment 18 of the bag 12 through the opening 16. The heating element 24 is activated, by either a switch (not shown) or by plugging in the power source in the appropriate power supply. The heating element 24, if not already operating, then heats the internal compartment 18 to about 120 degrees Fahrenheit. This temperature is sufficient to heat the external materials of the boots, other footwear, clothes, equipment or other materials in the compartment. The conduction of the heat through the external materials softens the outer shell plastic or material, and penetrates the lining materials. These lining materials and boot components are dried out as well as sterilized. Since the heat is radiating inwards from the outside, moisture is eliminated efficiently from the boot components unlike the prior devices that heated from the inside and out.

The user is then provided with a warm and dry boot or other article for the next use. In the case of ski or snow boots, the warm and soft materials are easy and comfortable to put on and easy to adjust. The otherwise cold, hard and unyielding plastics adapt easily and comfortably to the feet, and the warmth encountered by the user is enjoyed for as long as two hours in normal skiing temperatures. This translates into improved early performance and endurance, and creates a more enjoyable experience, particularly as the day warms and the skiers own energy level is increased.

Another preferred embodiment of the present invention is illustrated in FIGS. 4 6. The bag 50 of this embodiment includes a large zippered opening 52 for insertion of articles into an internal compartment 54. Heating element 56 extends along the inner wall 58 of the internal compartment 56. A protective fabric sleeve 58, in this preferred embodiment, protects the heating element 56. A power supply cord 60 extends through outlet hole 62 and is stored in a side compartment 64. An elastic cord 66 prevents accidental movement of the power cord from the side compartment.

The heating element 56 is not only covered by the protective fabric sleeve 58 but also insulation 70 and a reinforcement sheet 72 under the insulation and heating element. A stitched border tape, in this embodiment, is provided for finishing and protecting the edges of the heating element. An outer insulation element 74 is provided, formed of EVA foam or other materials, and laminated with a reflective material, such as silver heat reflective material. A shoulder strap 76 is also provided for ease of carrying.

Another preferred embodiment is illustrated in FIGS. 7 8. Bag 80 includes two separate compartments 82, 84 separated by an inner side wall 86. Zippered openings 88, 90 provide access into the compartments 82, 84, respectively. Heating element 92 extends along the outer side walls 94, 96 and lower base 98. The lower base is sufficiently strong to withstand impact from dropping the bag and also prevents heat leakage when the bag rests on a cold surface. The heating element, in one preferred embodiment, is in direct contact with the soles of the boot or other articles. The heating element 92 includes a power cord 100 extending through outlet hole 102. The power cord may be carried in a side mesh pocket for storage.

In another preferred embodiment, the heating element 92 is split into two separate heating elements, one for each compartment and/or with a central heating element in the central wall between the compartments.

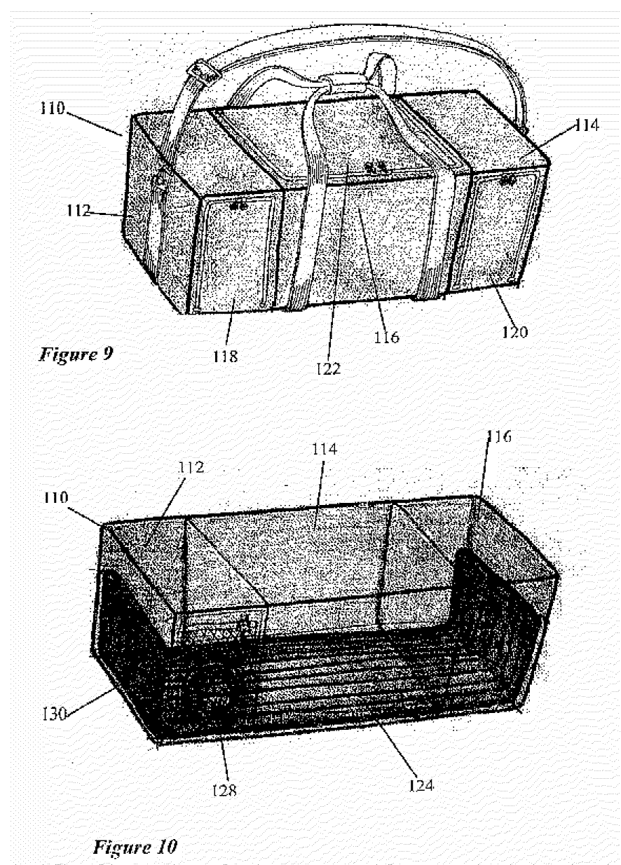

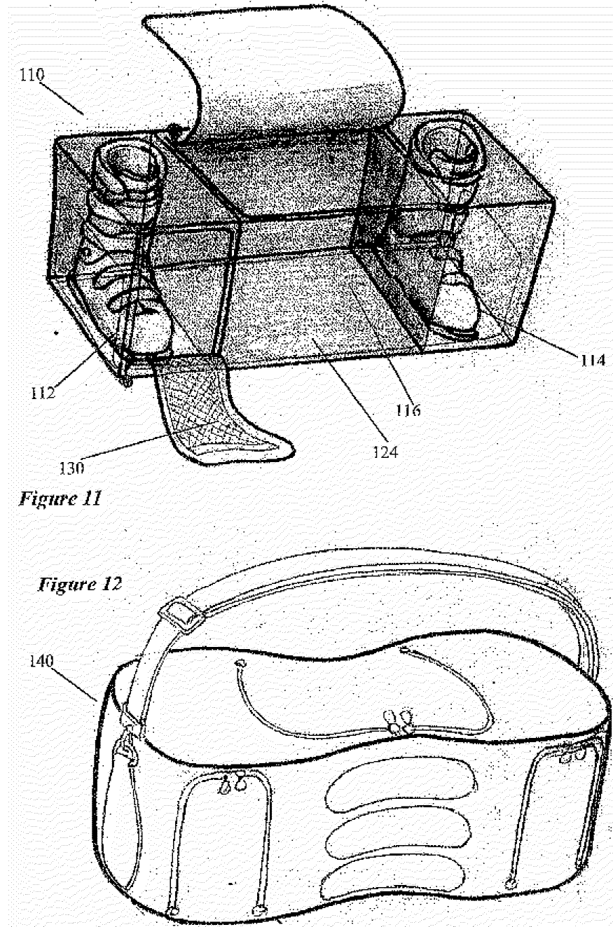

Another preferred embodiment of the present invention is illustrated in FIGS. 9 11. The bag 110 includes two side compartments 112, 114 separated by a central compartment 116. The side compartments 112, 114 are accessible by front or rear openings 118, 120, respectively and the central compartment by opening 122. Heating element(s) 124 extend along the outer walls of the side compartments and along the bottom surface of all three compartments. Alternatively, the compartments may be warmed by separate heating elements that may have separate controls. Power cord 128 is connected to the heating element and stored in pocket 130.

Another embodiment is shown in FIG. 12. The bag 140 is similar to the above described embodiment with a narrow central compartment for ease of carrying or for carrying more diverse articles. The shape of bag 140 provides a more ergonomic bag for ease of use. Bag 140 includes one or more compartments having heating elements, similar to those discussed above.

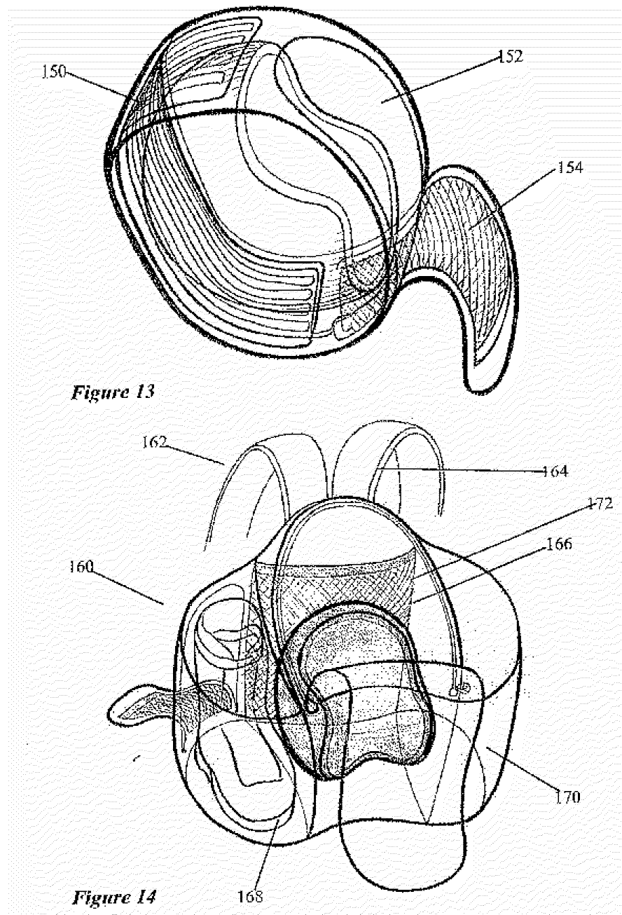

Another preferred embodiment of the present invention is shown in FIG. 13. This embodiment provides bag 150 that is more oval shaped to include a compartment 152 for a helmet or other protective head gear. The compartment 152 includes heating element 154, similar to the heating elements discussed in the other embodiments. The head gear often becomes soaked internally from body moisture as well as snow and ice melt. The heating element 154 enables the head gear to be dried and/or sterilized for comfort of the user. The bag 150 may also include additional compartments and associated heating elements to carry other articles as well.

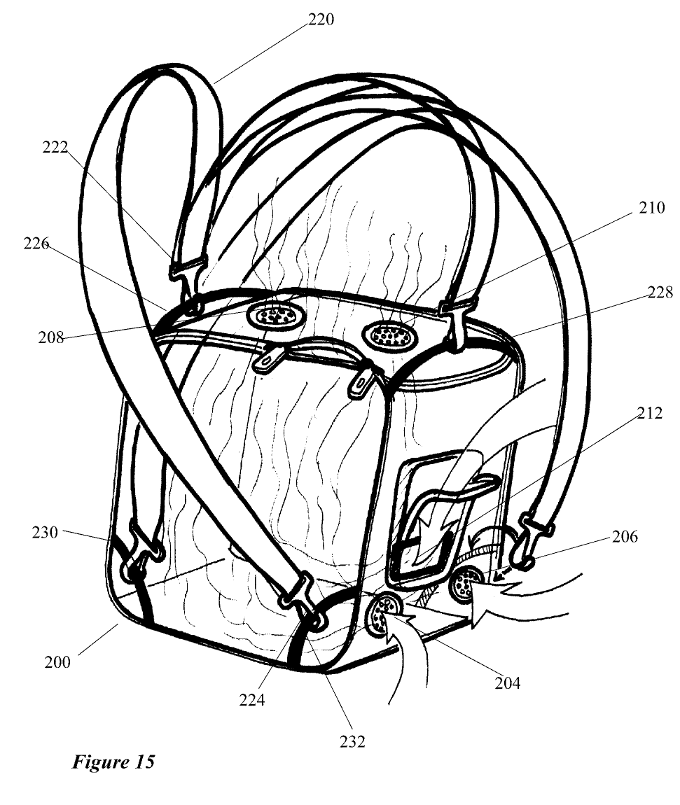

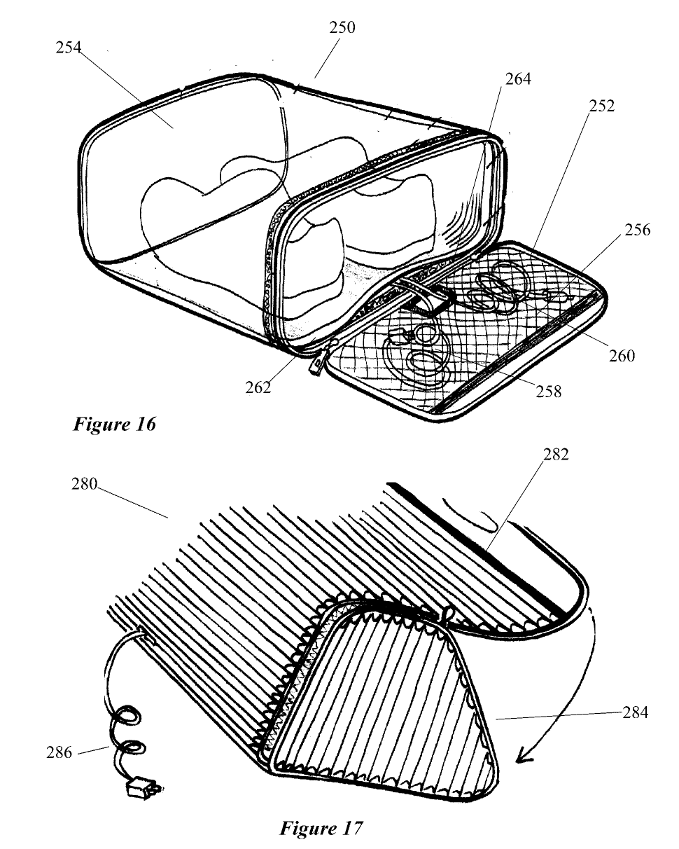

Another preferred embodiment is illustrated in FIG. 14. This embodiment provides a backpack 160 having shoulder straps 162, 164. Backpack 160 also includes at least one compartment 166, and as shown in FIG. 15, may also include additional compartments 168, 170. Heating elements 172 are included in each of the compartments, similar in manner as the above described heating elements and controls.

Other embodiments of the present invention include box like compartments that may hold one pair of boots, two pairs of boots, or more pairs of boots. These box compartments are usable inside of lodging, locker rooms, storage facilities or other facilities where transporting them is not an issue. In one preferred embodiment, rows of compartment boxes with heating elements as described above may be used as a commercial site for storing and drying of boots, shoes, other footwear and other articles. These compartment boxes may be electrically linked together for ease of operation.

An alternative embodiment is illustrated in FIG. 15. This embodiment is similar to the above described embodiments with additional features. The bag 200 includes zippered compartment 202 with heating elements (not shown) similar to the above described heating elements. Inlet ventilation elements 204, 206 and outlet ventilation elements 208, 210 allow the humidity to escape from the compartment 202 as the boots or other wet items are heated. This provides more efficient heating and drying of the items in the compartment. Ventilation element 212 may be provided in a compartment that may be opened as needed in addition or in place of the ventilation elements 204 210.

Another feature shown in the embodiment illustrated in FIG. 15 is the use of straps in various configurations. Strap 220 includes clasps 222 and 224 on either end of the strap. The strap can engage the bag 200 in a variety of places. For example, The bag 200 as shown in the illustration includes engagement straps 226 and 228 on each end of the upper portion of the bag and engagement straps 230, 232, and 234, 236 (not shown) on the lower corners of the bag. The strap 220 can then be secured between the upper straps 226, 228 to create a typical over the shoulder carrying position, or between an upper strap 226 and lower corner strap 232 to create a cross-body carrying position or between any two of the engagement straps to provide multiple carrying positions.

Another embodiment of the bag is illustrated in FIG. 16. The bag 250 includes a rectangular box shape to conserve space. The bag includes a zippered end opening 252 to allow access to the heated compartment 254. The end 252 includes a mesh compartment 256 that contains the electrical cords 258, 260 similar to the above described electrical power cords. A tubular heating element sleeve 262 is easily inserted and removed from the compartment 254. A hook and loop fastener 264 secures the tubular heating element sleeve 262 to the compartment 254. The heating element sleeve 262 may also be permanently secured to the compartment as well. This bag 250 is particularly useful in drying shoes and other smaller items.

Another embodiment of bag suitable for drying and heating shoes and other smaller items is illustrated in FIG. 17. The bag 280 includes an angularly shaped bag that has a zippered top flat 282 to allow access into the heating compartment 284. The electrical cords 286 may be accessed from the rear, sides or other suitable locations.

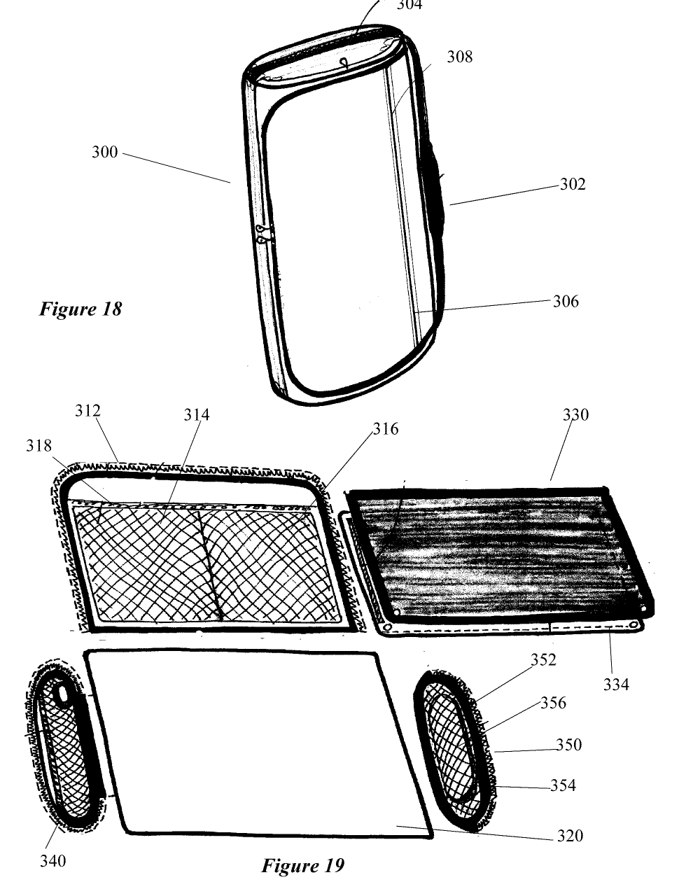

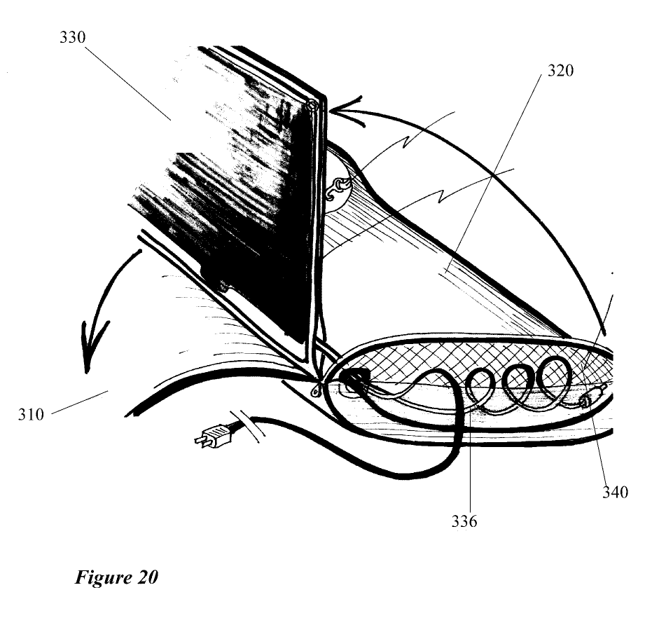

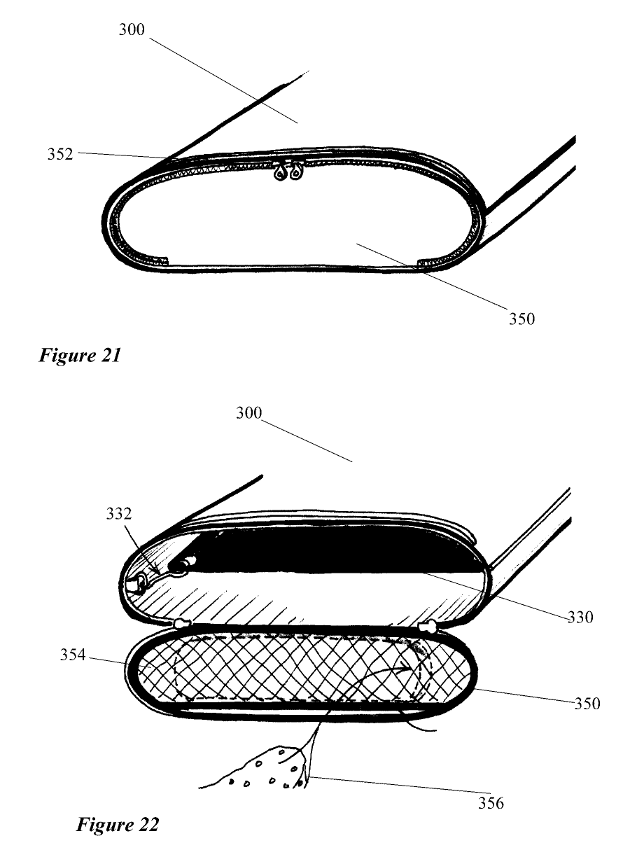

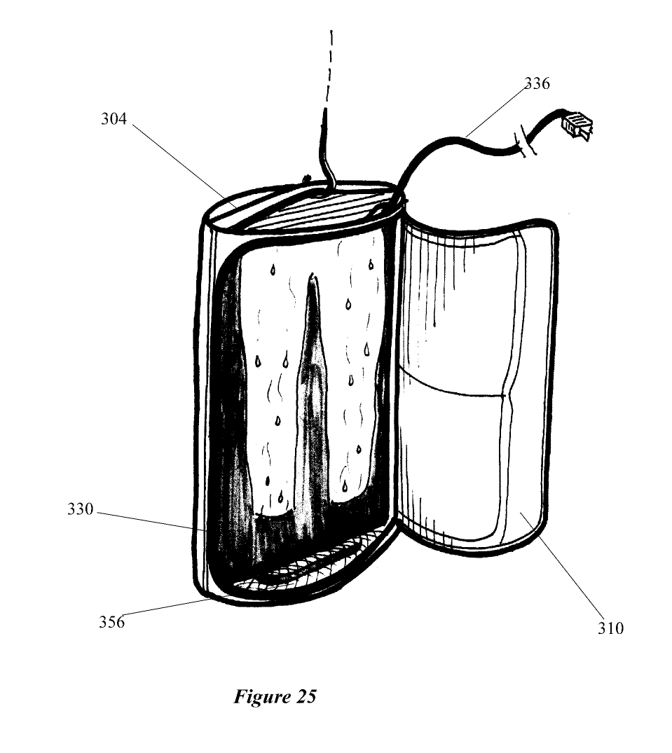

The embodiment illustrated in FIGS. 18 through 25 is yet another preferred embodiment of the present invention. This embodiment has utility for drying large garments, such as wet suits, dry suits, and even ski suits or other relatively large garments that may be wet or damp after use. The bag 300, as shown in FIG. 18, is in this descriptive embodiment about the size of a garment suit bag. The bag 300 includes a shoulder strap 302, a hanging strap 304 and a zippered top flap 306. The top flap 306 includes another zipper 308 that allows access into a storage pocket.

The top flap 306 is unzipped to allow access into the storage compartment 310. The storage compartment 310 is formed from a top panel 312 that is secured to the top flap 306. The top panel includes two large mesh pockets 314, 316 for storage. An elastic binding 318 holds the mesh pockets closed. The storage compartment 310 also includes a bottom panel 320. A center sleeve 330 is inserted between the top panel and the bottom panel and secured there by fasteners, such as hooks 332 or other known fastening mechanisms.

The center sleeve 330 includes a heating element 334 that is secured inside the sleeve 330 by hook and loop fasteners or other known fastening mechanisms. The heating element is similar in design to the heating elements discussed above. The heating element 334 is powered by a transformer and power cords 336 as discussed above.

The bag 300 also includes top side panel 340 and bottom side panel 350. Top side panel includes a zipper or other fastening mechanism to allow access into the compartment. The top side panel 340 also includes a pocket that will store the power cords 336 when not in use. The top side panel can be partially unzipped to allow access to the power cords. The bottom side panel also includes a zipper or other fastening mechanism. An elastic mesh pocket 354 is also formed in the inner side of the bottom side panel. Water absorbing sponges 356 are stored in the pocket 354 to collect moisture from the wet item as it dries as discussed in greater detail below. These sponges can be removed to squeeze the water from them periodical ly.

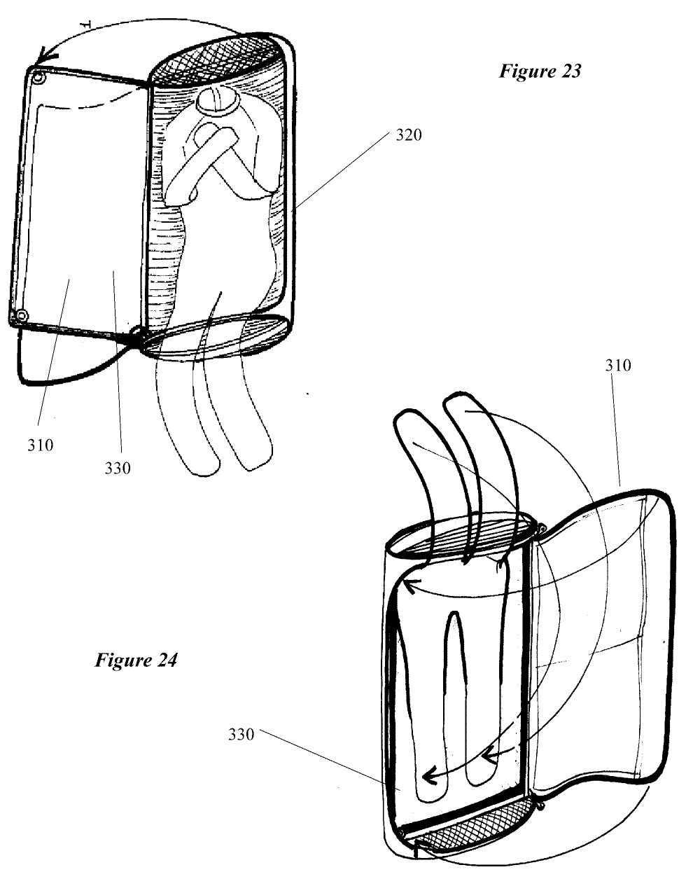

In use, as shown in FIGS. 23 through 25, the bag 300 is used to store and dry a wet suit such as used in underwater diving, kayaking and other water sports. Other items may be dried as well. The top flap 306 of the bag 300 is opened and the center sleeve 330 is raised. The suit is laid so that half of the suit is on the bottom panel 320 of the bag. The center sleeve 330 is then placed down onto the suit and fastened in place. The remaining half of the suit is then folded over the center sleeve 330. Preferably, the bag is then hung by the strap 304 in a vertical orientation. The top flap 306 can be left open to allow evaporation of moisture during the drying process, or closed. The appropriate electrical cord 336 is plugged in and the heating elements within the center sleeve begin drying the suit. The bottom side panel 350 can be opened to allow moisture to drain out or the moisture can be collected by the sponges 356. The wet suit wearer will then have a dry and warm suit to wear.

It is to be expressly understood that while the above descriptive embodiments discussed use with boots, these heated compartments may be usable for other articles as well. For example, hiking footwear, sports footwear, sports clothing, sports equipment, fishing gear, work clothes, work equipment, and many other articles where drying is of concern may be used. Also, the compartment bags may also be useful in food service, to transport and/or maintain the temperature of foot items. Another critical use may be in the medical field to maintain the temperature of medical devices or organs. The present invention is considered for use wherever it is desired to maintain the temperature and/or dry articles.

The above described embodiments are expressly intended for explanatory purposes and not to limit the scope of the claimed inventions.

1. A drying and heating system for use with sports equipment and other articles of use, said system comprising:
a transportable container;
at least one compartment in said transportable container having walls;
a center panel in at least one of said at least one compartment;
at least one heating element in said center panel;
a power supply connected to said transportable container for providing power to said at least one heating element.

2. The system of claim 1 wherein said system further includes:
at least one access opening to allow moisture to evaporate during the drying of an item.

3. The system of claim 1 wherein said system further includes:
said power supply having dual voltage means for supplying AC and DC power to said at least one heating element.

4. The drying and heating system of claim 1 wherein said system further includes:
at least one water retention device for collecting moisture during the drying of an item.

5. The heating and drying system of claim 1 wherein said heating element includes:
a thermostat to control the temperature of said heating element.

6. The heating and drying system of claim 1 wherein said power source includes:
an electrical converter connectable to an external power supply.

7. The heating and drying system of claim 1 wherein said power source includes:
a DC battery power supply contained in said transportable container.

8. The heating and drying system of claim 1 wherein said power supply includes:
an AC power supply and a DC battery power supply contained in said transportable container.

9. A drying and heating system for use with sports equipment and other articles of use, said system comprising:
a transportable container;
at least one compartment in said transportable container having walls;
at least one heating element in one of said walls;
a power supply connected to said transportable container for providing power to said at least one heating element; and
ventilation openings in said at least one compartment to allow moisture to evaporate during the drying process.

10. The system of claim 9 wherein said system further includes:
at least two access openings to allow moisture to evaporate during the drying of an item.

11. The system of claim 9 wherein said system further includes:
said power supply having dual voltage means for supplying AC and DC power to said at least one heating element.

12. The drying and heating system of claim 9 wherein said system further includes:
at least one water retention device for collecting moisture during the drying of an item.

13. The heating and drying system of claim 9 wherein said heating element includes:
a thermostat to control the temperature of said heating element.

14. The heating and drying system of claim 9 wherein said power source includes:
an electrical converter connectable to an external power supply.

15. The heating and drying system of claim 9 wherein said power source includes:
a DC battery power supply contained in said transportable container.

16. The heating and drying system of claim 9 wherein said power supply includes:
an AC power supply and a DC battery power supply contained in said transportable container.

17. The heating and drying system of claim 9 wherein said transportable container includes:
at least one strap having fastening mechanisms on each end; and
a plurality of engagement points on said transportable container for securing said at least one strap in a plurality of different configurations.
